(19) United States
(12) Patent Application Publication
(10) Pub. No.: US 2025/0196711 A1
(43) Pub. Date: Jun. 19, 2025

(54) POWER SYSTEM

(71) Applicant: TOYOTA JIDOSHA KABUSHIKI KAISHA, Toyota-shi (JP)

(72) Inventor: Ryuki HIRONO, Nagoya-shi (JP)

(73) Assignee: TOYOTA JIDOSHA KABUSHIKI KAISHA, Toyota-shi (JP)

(21) Appl. No.: 18/958,476

(22) Filed: Nov. 25, 2024

(30) Foreign Application Priority Data
Dec. 15, 2023 (JP) 2023-212281

(51) Int. Cl. B60L 58/13; B60L 8/00; B60L 58/20; H02J 7/00; H02J 7/34; H02J 7/35

(52) U.S. Cl. CPC B60L 58/13; B60L 8/003; B60L 58/20; H02J 7/00712; H02J 7/342; H02J 7/35; B60L 2210/10; H02J 2207/40

(57) ABSTRACT

A power system mounted on a vehicle includes a solar panel, an auxiliary battery, a driving battery, a DCDC converter that receives electric power of the solar panel and electric power of the auxiliary battery and outputs electric power of a predetermined voltage to the driving battery, and a control unit that controls DCDC converter. When a storage amount of the auxiliary battery is equal to or greater than a first value, the control unit sets the output power of the DCDC converter to a second value in which the power generated by the solar panel and the power of the auxiliary battery are supplied to the driving battery in parallel.

### CROSS-REFERENCE TO RELATED APPLICATION

This application claims priority to Japanese Patent Application No. 2023-212281 filed on Dec. 15, 2023, incorporated herein by reference in its entirety.

### BACKGROUND

### 1. Technical Field

The present disclosure relates to a power system mounted on a vehicle.

### 2. Description of Related Art

Japanese Unexamined Patent Application Publication No. 2014-007822 (JP 2014-007822 A) discloses a charging apparatus for a vehicle. The charging apparatus can charge the driving battery (high-voltage battery) with the power generated by the solar panel or the power stored in the auxiliary battery (low-voltage battery) via the direct current-direct current (DCDC) converter through switching of the switch.

### SUMMARY

The charging apparatus for a vehicle disclosed in JP 2014-007822 A is configured to charge the driving battery with either one selected from the power generated by the solar panel and the power of the auxiliary battery through switching of the switch. Therefore, in a situation where the state of charging the driving battery with the power generated by the solar panel is selected, if the power generated by the solar panel fluctuates due to the influence of solar radiation or the like, the conversion efficiency of the DCDC converter may be reduced.

The present disclosure has been made in view of the above-described problem, and provides a power system capable of suppressing a reduction in conversion efficiency of a DCDC converter due to a fluctuation in power generated by a solar panel.

One aspect of the disclosed technique is a power system mounted on a vehicle. The power system includes:
a solar panel;
an auxiliary battery;
a driving battery;
a DCDC converter that inputs the power of the solar panel and the power of the auxiliary battery and outputs the power of a predetermined voltage to the driving battery; and
a control unit that controls the DCDC converter.
   When a storage amount of the auxiliary battery is equal to or greater than a first value, the control unit sets the output power of the DCDC converter to a second value in which the power generated by the solar panel and the power of the auxiliary battery are supplied to the driving battery in parallel.

According to the power system of the present disclosure, when the storage amount of the auxiliary battery is equal to or greater than the first value, the driving battery is charged with the combined power of the power generated by the solar panel and the power of the auxiliary battery. This enables the DCDC converter to be constantly driven at a high conversion efficiency while absorbing the fluctuation in the power generated by the solar panel by the auxiliary battery, which makes it possible to suppress the reduction in the conversion efficiency of DCDC converter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power system according to an embodiment of the present disclosure;

FIG. 2 is a process flow chart of charge control executed by the power system; and

FIG. 3 is a diagram illustrating an exemplary conversion-efficiency of the output power of DCDC converter.

### DETAILED DESCRIPTION OF EMBODIMENTS

The power system according to the present disclosure supplies, to the driving battery, electric power obtained by combining the generated electric power of the solar panel and the electric power of the auxiliary battery when the amount of electric power stored in the auxiliary battery is sufficient. Accordingly, the driving battery can be charged while DCDC converter is constantly driven with high-efficiency while absorbing the variation of the generated electric power of the solar panel by the auxiliary battery. Hereinafter, an embodiment of the present disclosure will be described in detail with reference to the drawings.

### EMBODIMENT

### Configuration

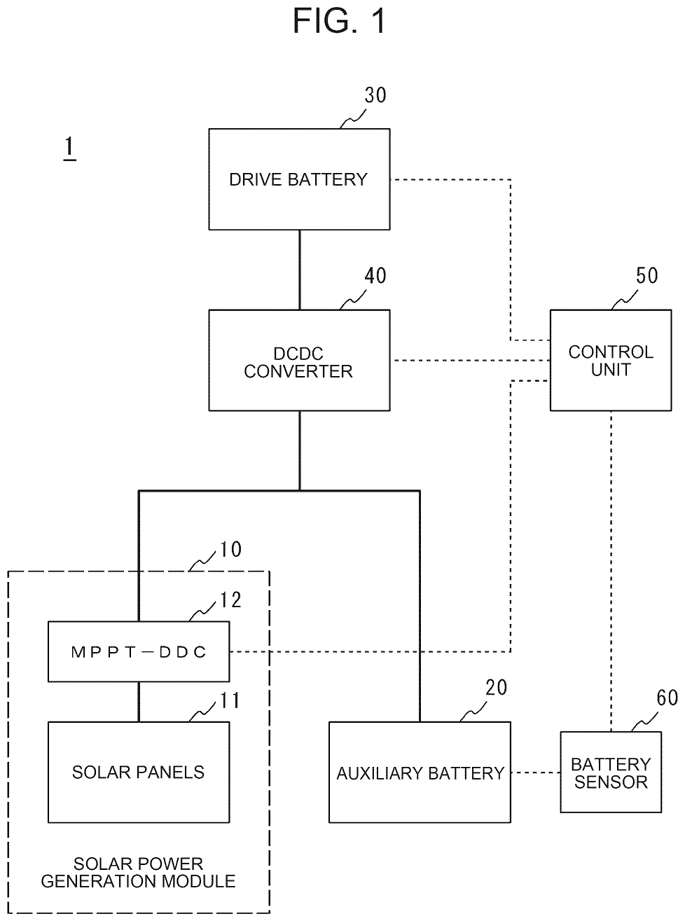

FIG. 1 is a block diagram illustrating a schematic configuration of a power system 1 according to an embodiment of the present disclosure. The power system 1 illustrated in FIG. 1 includes a solar power generation module 10, an auxiliary battery 20, a driving battery 30, a DCDC converter 40, a control unit 50, and a battery sensor 60. In FIG. 1, a power line through which power is transmitted and received is indicated by a solid line, and a signal line through which a detection value, a control instruction, or the like flows is indicated by a broken line. The power system 1 is mounted on vehicles such as hybrid electric vehicle (HEV), plug-in hybrid electric vehicle (PHEV), and battery electric vehicle (BEV).

The solar power generation module 10 is a power generation device that generates electric power by being irradiated with sunlight, and outputs the generated electric power to the auxiliary battery 20 and DCDC converter 40 connected to the solar power generation module 10. The solar power generation module 10 includes a solar panel 11 and an MPPT-DDC12.

The solar panel 11 is an assembly of solar cells. MPPT-DDC12 is a DCDC converter (DDC) that outputs electric power generated by the solar panel 11 at a predetermined voltage based on the maximum-power-point tracking (MPPT) control.

The auxiliary battery 20 is a secondary battery configured to be chargeable and dischargeable, such as a lithium-ion battery. The auxiliary battery 20 is connected to the solar power generation module 10 so as to be able to be charged by electric power generated in the solar panel 11. The auxiliary battery 20 is connected to DCDC converter 40 so that the driving battery 30 can be charged by the electric power stored therein.

The driving battery 30 is a secondary battery configured to be chargeable and dischargeable, such as a lithium ion battery. The driving battery 30 is connected to the solar power generation module 10 and the auxiliary battery 20 via DCDC converter 40 so that the electric power generated in the solar panel 11 and the electric power of the auxiliary battery 20 can be charged. The driving battery 30 is a high-voltage battery having a higher rated voltage than the auxiliary battery 20.

DCDC converter 40 is a power converter capable of converting the inputted power into a predetermined-voltage power and outputting the converted power. DCDC converter 40 has one end (primary side) connected to the solar power generation module 10 and the auxiliary battery 20, and the other end (secondary side) connected to the driving battery 30. DCDC converter 40 may boost the voltages of the solar power generation module 10 and the auxiliary battery 20 inputted to the primary side and may be outputted as the voltage of the secondary side. The operation of DCDC converter 40 is controlled by the control unit 50.

The control unit 50 is an electronic control unit (ECU) that controls the power system 1. The control unit 50 acquires information on the generated electric power from the solar power generation module 10, and acquires information on the amount of electricity stored in the auxiliary battery 20 from the battery sensor 60. Then, the control unit 50 controls the operation of DCDC converter 40 based on the acquired data.

The battery sensor 60 is a sensor for detecting the physical quantity of the auxiliary battery 20. Examples of the physical quantity of the auxiliary battery 20 include voltage, current, temperature, and State Of Charge (SOC).

### Control

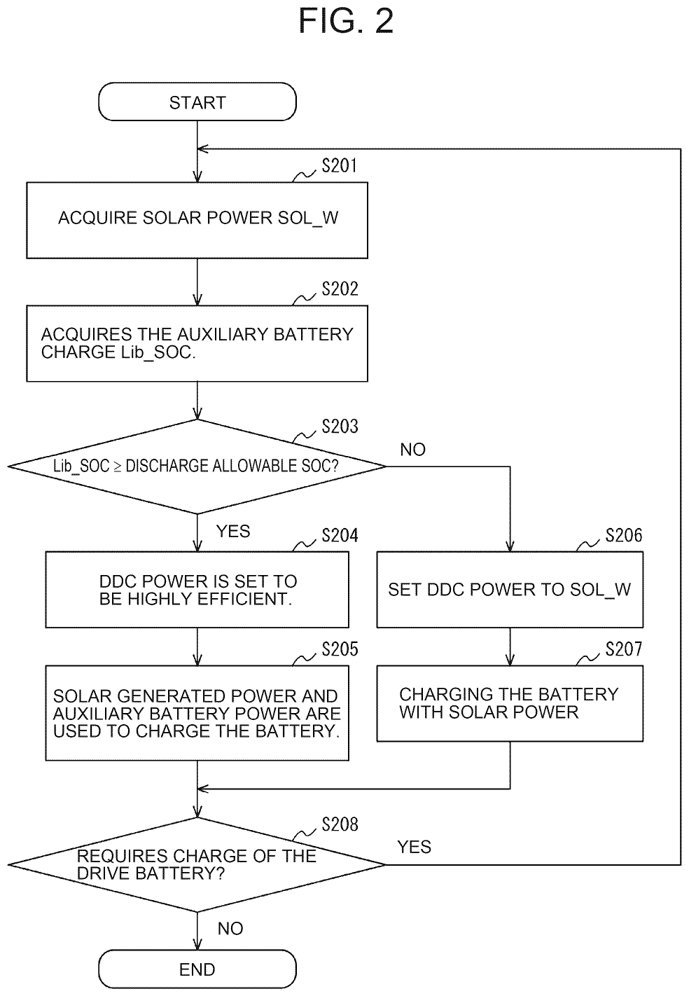

Next, with further reference to FIG. 2, control performed by the power system 1 according to the present embodiment will be described. FIG. 2 is a flowchart for explaining a procedure of charge control executed by the power system 1.

The charging control illustrated in FIG. 2 is started when the amount of electricity stored in the driving battery 30 in the vehicle is reduced to a predetermined value and it is determined by the power system 1 that the charging of the driving battery 30 is necessary.

### S201

The control unit 50 of the power system 1 acquires, from MPPT-DDC12, electric power (solar generated electric power SOL_W) generated by the solar panel 11 of the solar power generation module 10. When the control unit 50 acquires the solar generated electric power SOL_W, the process proceeds to S202.

### S202

The control unit 50 of the power system 1 acquires the electric power stored in the auxiliary battery 20 (the auxiliary battery storage amount Lib_SOC) from the battery sensor 60. When the auxiliary battery storage amount Lib_SOC is acquired by the control unit 50, the process proceeds to S203.

### S203

The control unit 50 of the power system 1 determines whether the auxiliary battery storage amount Lib_SOC is equal to or greater than the discharging allowable SOC. The discharging allowable SOC is a predetermined amount of electric power (first value) that is allowed to be supplied (charged) from the auxiliary battery 20 to the driving battery 30, and is set to an appropriate value based on the performance and capacity of the auxiliary battery 20, the guaranteed life, and the like. When the control unit 50 determines that the auxiliary battery storage amount Lib_SOC is equal to or greater than the discharging allowable SOC (S203, Yes), the process proceeds to S204. On the other hand, when the control unit 50 determines that the auxiliary battery storage amount Lib_SOC is less than the discharging allowable SOC (S203, No), the process proceeds to S206.

### S204

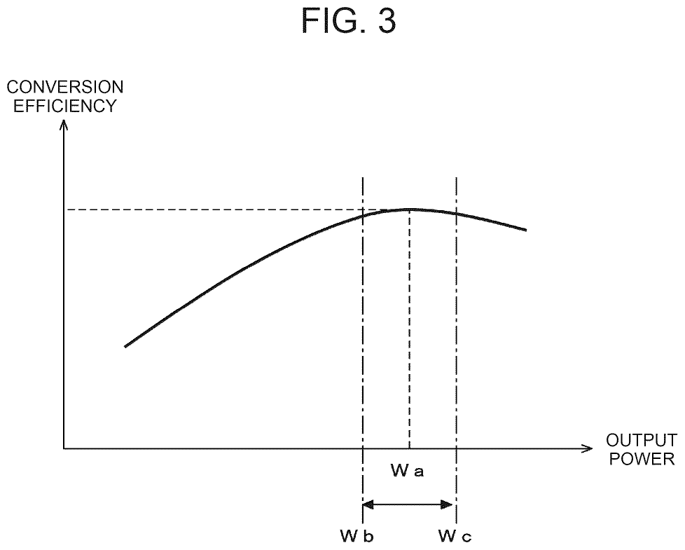

The control unit 50 of the power system 1 sets (controls) the output power of DCDC converter 40 (DDC) to a power (second value) at which the converting operation of DCDC converter 40 is highly efficient, which is determined in advance. FIG. 3 shows an exemplary conversion-efficiency of the output power of DCDC converter 40. As illustrated in FIG. 3, as the output power of DCDC converter 40, the output power Wa having the highest conversion efficiency may be set, or any one of Wc may be set from the output power Wb having the higher conversion efficiency. When the control unit 50 sets the output power of DCDC converter 40 (DDC) to be highly efficient, the process proceeds to S205.

### S205

The power system 1 charges the driving battery 30 by the solar generated electric power SOL_W and the electric power of the auxiliary battery 20. In this charge, when the solar generated electric power SOL_W is equal to or higher than the power outputted from DCDC converter 40 set in the above S204, the electric power is not taken out from the auxiliary battery 20. On the other hand, when the solar generated power SOL_W is less than the output power of DCDC converter 40, the auxiliary battery 20 takes out the amount of power that is insufficient for the output power. That is, the electric power of the auxiliary battery 20 absorbs the variation of the solar generated electric power SOL_W that varies due to environmental factors such as the amount of solar radiation to the solar panel 11. When the driving battery 30 is charged using the solar generated electric power SOL_W and the electric power of the auxiliary battery 20, the process proceeds to S208.

### S206

The control unit 50 of the power system 1 sets the output power of DCDC converter 40 (DDC) to the solar generated power SOL_W. With this setting, only the generated electric power of the solar power generation module 10 is outputted to the driving battery 30 via DCDC converter 40. When the output power of DCDC converter 40 (DDC) is set to the solar generated power SOL_W by the control unit 50, the process proceeds to S207.

### S207

The power system 1 charges the driving battery 30 with the solar generated power SOL_W. In this charge, since the power outputted from DCDC converter 40 is equal to the solar generated power SOL_W, power removal from the auxiliary battery 20 does not occur. Therefore, it is possible to suppress the auxiliary battery 20 from being depleted. When the driving battery 30 is charged using the solar generated electric power SOL_W, the process proceeds to S208.

### S208

The power system 1 determines whether the driving battery 30 needs to be charged. When the power system 1 determines that the driving battery 30 for driving needs to be continuously charged (S208, Yes), the process proceeds to S201. On the other hand, when the power system 1 determines that charging of the driving battery 30 is no longer required (S208, No), the present charging control is ended.

### Operations and Effects

As described above, according to the power system 1 according to the embodiment of the present disclosure, when the power storage amount of the auxiliary battery 20 has enough power to charge the driving battery 30, the following control is performed. That is, DCDC converter 40 is made highly efficient so that the generated electric power of the solar panel 11 can be preferentially supplied, and the generated electric power of the solar panel 11 and the electric power of the auxiliary battery 20 are supplied to the driving battery 30 in parallel.

By this feed control, DCDC converter 40 can be driven at all times in a highly conversion-efficient range. In addition, since the variation in the generated power of the solar panel 11 can be absorbed by adjusting the electric power taken out from the auxiliary battery 20, it is not necessary to provide a dedicated battery for absorbing the generated electric power.

Further, according to the power system 1 according to the embodiment of the present disclosure, when there is not enough power to charge the driving battery 30 in the storage amount of the auxiliary battery 20, only the generated power of the solar panel 11 is supplied to the driving battery 30.

By this supply control, it is possible to suppress the electric power from being taken out from the auxiliary battery 20, and it is possible to suppress the auxiliary battery 20 from being depleted.

An embodiment of the present disclosure has been described above. The present disclosure can be viewed not only as a power system, but also as a method executed by the power system, a program of the method, a computer-readable non-transitory storage medium storing the program, a vehicle equipped with the power system, and the like.

The power system of the present disclosure can be used in a vehicle or the like in which a solar panel is mounted.

What is claimed is:

1. A power system mounted on a vehicle, the power system comprising:
a solar panel;
an auxiliary battery;
a driving battery;
a direct current-direct current (DCDC) converter that inputs power of the solar panel and power of the auxiliary battery and outputs power of a predetermined voltage to the driving battery; and
a control unit that controls the DCDC converter, wherein when a storage amount of the auxiliary battery is equal to or greater than a first value, the control unit sets the output power of the DCDC converter to a second value in which the power generated by the solar panel and the power of the auxiliary battery are supplied to the driving battery in parallel.

2. The power system according to claim 1, wherein the second value is the output power at which a conversion efficiency of the DCDC converter is maximized.

3. The power system according to claim 1, wherein when a storage amount of the auxiliary battery is less than the first value, the control unit sets the output power of the DCDC converter to the power generated by the solar panel.

4. The power system according to claim 1, wherein the first value is a storage amount such that the auxiliary battery does not run short of power.
